(19) United States
(12) Patent Application Publication
(10) Pub. No.: US 2014/0355152 A1
(43) Pub. Date: Dec. 4, 2014

(54) INTERLAYER COUPLED FREE LAYER WITH OUT OF PLANE MAGNETIC ORIENTATION FOR MAGNETIC READ HEAD

(71) Applicant: HGST Netherlands B.V., Amsterdam (NL)

(72) Inventors: Chando Park, Palo Alto, CA (US); James M. Freitag, Sunnyvale, CA (US); Sangmun Oh, San Jose, CA (US); Zheng Gao, San Jose, CA (US)

(73) Assignee: HGST Netherlands B.V., Amsterdam (NL)

(21) Appl. No.: 13/904,993

(22) Filed: May 29, 2013

(51) Int. Cl. G11B 5/147

(52) U.S. Cl. CPC G11B 5/147; G11B 5/1475
USPC 360/75; 428/816; 427/127; 427/131

(57) ABSTRACT

In one embodiment, a magnetic head includes a reference layer having magnetic orientation about aligned with a plane of deposition thereof; a first free layer having a magnetic orientation out of a plane of deposition thereof; a spacer layer between the reference layer and the first free layer; a second free layer having a magnetic orientation out of a plane of deposition thereof; and an inserting layer between the first and second free layers.

### FIELD OF THE INVENTION

The present invention relates to data storage systems, and more particularly, this invention relates to magnetic read heads having an interlayer coupled free layer with out of plane magnetic orientation relative to a plane of deposition thereof, and method for forming.

### BACKGROUND

The heart of a computer is a magnetic hard disk drive (HDD) which typically includes a rotating magnetic disk, a slider that has read and write heads, a suspension arm above the rotating disk and an actuator arm that swings the suspension arm to place the read and/or write heads over selected circular tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

The volume of information processing in the information age is increasing rapidly. In particular, it is desired that HDDs be able to store more information in their limited area and volume. A technical approach to this desire is to increase the capacity by increasing the recording density of the HDD. To achieve higher recording density, further miniaturization of recording bits is effective, which in turn typically requires the design of smaller and smaller components.

The further miniaturization of the various components, however, presents its own set of challenges and obstacles.

One such obstacle is the need for hard and/or soft bias materials in conventional magnetic read heads. The read head sensor must be adequately biased and stabilized by providing deposition of appropriate hard or soft bias materials to form a contiguous junction between the sensor and bias layer. However, hard and/or soft bias materials in conventional magnetic read heads take up valuable space and inhibit the reduction in size thereof. Furthermore, biasing layers bias the magnetic orientation of the free layer to be in the plane of deposition thereof, which may be undesirable, e.g., as the size of data tracks continue to become smaller.

### SUMMARY

In one embodiment, a magnetic head includes a reference layer having magnetic orientation about aligned with a plane of deposition thereof; a first free layer having a magnetic orientation out of a plane of deposition thereof; a spacer layer between the reference layer and the first free layer; a second free layer having a magnetic orientation out of a plane of deposition thereof; and an inserting layer between the first and second free layers.

In another embodiment, a magnetic head includes a reference layer having magnetic orientation about aligned with a plane of deposition thereof; a first free layer having a magnetic orientation about perpendicular to a plane of deposition thereof; a spacer layer between the reference layer and the first free layer; a second free layer having a magnetic orientation about perpendicular to a plane of deposition thereof; and a nonmagnetic inserting layer between the first and second free layers.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head. Such embodiments may also be implemented in magnetic sensor and magnetic memory application.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system.

FIG. 2A is a schematic representation in section of a recording medium utilizing a longitudinal recording format.

FIG. 2B is a schematic representation of a conventional magnetic recording head and recording medium combination for longitudinal recording as in FIG. 2A.

FIG. 2C is a magnetic recording medium utilizing a perpendicular recording format.

FIG. 2D is a schematic representation of a recording head and recording medium combination for perpendicular recording on one side.

FIG. 2E is a schematic representation of a recording apparatus adapted for recording separately on both sides of the medium.

FIG. 3A is a cross-sectional view of one particular embodiment of a perpendicular magnetic head with helical coils.

FIG. 3B is a cross-sectional view of one particular embodiment of a piggyback magnetic head with helical coils.

FIG. 4A is a cross-sectional view of one particular embodiment of a perpendicular magnetic head with looped coils.

FIG. 4B is a cross-sectional view of one particular embodiment of a piggyback magnetic head with looped coils.

FIG. 5 is a partial air bearing surface view of a magnetic tunnel junction (MTJ) sensor with according to one embodiment.

FIG. 6A is a partial air bearing surface view of a sensor according to another embodiment.

FIG. 6B is a detailed view taken from Box 6B in FIG. 6A.

FIG. 7 is a flowchart for a method according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

Moreover, unless otherwise specifically defined herein, conventional materials may be used to form any of the components of the various embodiments.

It must also be noted that, as used in the specification and the appended claims, the singular forms “a,” “an” and “the” include plural referents unless otherwise specified.

The following description discloses several preferred embodiments of disk-based storage systems and/or related systems and methods which address poor readback quality in conventional magnetic read heads, as well as operation and/or component parts thereof.

As described above, conventional magnetic read heads suffer from degradation of writing quality as they require one or more biasing layers which establish a biasing magnetic orientation in the plane of deposition thereof. However, these limitations impede the further miniaturization of magnetic read heads, and reading improvements thereof.

In sharp contrast, various embodiments described and/or suggested herein introduce ferromagnetic coupling between free layers; moreover, the interlayer ferromagnetic coupling influences a desirable magnetic orientation out of the plane of deposition, thereby eliminating the need for hard bias layers as seen in conventional products. Also, a perpendicular free layer configuration could be more favorable for future head generations with very narrow track width.

In one general embodiment, a magnetic head includes a reference layer having magnetic orientation about aligned with a plane of deposition thereof; a first free layer having a magnetic orientation out of a plane of deposition thereof; a spacer layer between the reference layer and the first free layer; a second free layer having a magnetic orientation out of a plane of deposition thereof; and an inserting layer between the first and second free layers

In another general embodiment, a magnetic head includes a reference layer having magnetic orientation about aligned with a plane of deposition thereof; a first free layer having a magnetic orientation about perpendicular to a plane of deposition thereof; a spacer layer between the reference layer and the first free layer; a second free layer having a magnetic orientation about perpendicular to a plane of deposition thereof; and a nonmagnetic inserting layer between the first and second free layers.

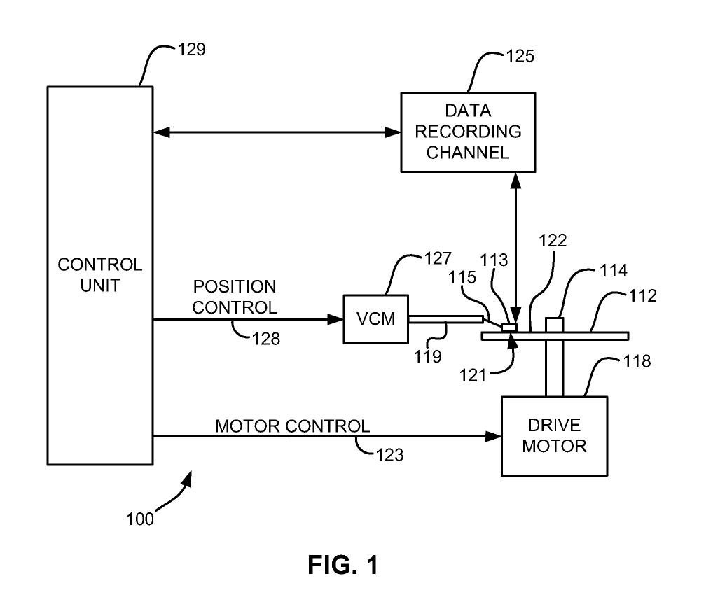

Referring now to FIG. 1, there is shown a disk drive 100 in accordance with one embodiment of the present invention. As shown in FIG. 1, at least one rotatable magnetic medium (e.g., magnetic disk) 112 is supported on a spindle 114 and rotated by a drive mechanism, which may include a disk drive motor 118. The magnetic recording on each disk is typically in the form of an annular pattern of concentric data tracks (not shown) on the disk 112. Thus, the disk drive motor 118 preferably passes the magnetic disk 112 over the magnetic read/write portions 121, described immediately below.

At least one slider 113 is positioned near the disk 112, each slider 113 supporting one or more magnetic read/write portions 121, e.g., of a magnetic head according to any of the approaches described and/or suggested herein. As the disk rotates, slider 113 is moved radially in and out over disk surface 122 so that portions 121 may access different tracks of the disk where desired data are recorded and/or to be written. Each slider 113 is attached to an actuator arm 119 by means of a suspension 115. The suspension 115 provides a slight spring force which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122 which exerts an upward force or lift on the slider. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by controller 129, such as access control signals and internal clock signals. Typically, control unit 129 comprises logic control circuits, storage (e.g., memory), and a microprocessor. In a preferred approach, the control unit 129 is electrically coupled (e.g., via wire, cable, line, etc.) to the one or more magnetic read/write portions 121, for controlling operation thereof. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write portions 121 by way of recording channel 125.

The above description of a typical magnetic disk storage system, and the accompanying illustration of FIG. 1 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write portion includes a coil layer embedded in one or more insulation layers (insulation stack), the insulation stack being located between first and second pole piece layers. A gap is formed between the first and second pole piece layers by a gap layer at an air bearing surface (ABS) of the write portion. The pole piece layers may be connected at a back gap. Currents are conducted through the coil layer, which produce magnetic fields in the pole pieces. The magnetic fields fringe across the gap at the ABS for the purpose of writing bits of magnetic field information in tracks on moving media, such as in circular tracks on a rotating magnetic disk.

The second pole piece layer has a pole tip portion which extends from the ABS to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

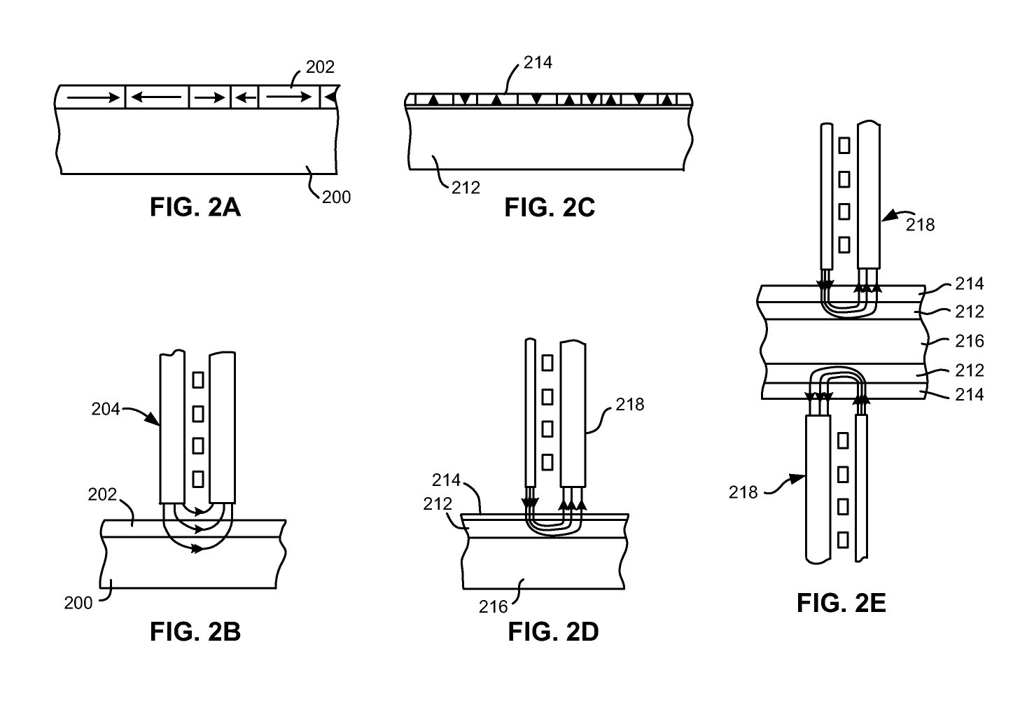

FIG. 2A illustrates, schematically, a conventional recording medium such as used with magnetic disc recording systems, such as that shown in FIG. 1. This medium is utilized for recording magnetic impulses in or parallel to the plane of the medium itself. The recording medium, a recording disc in this instance, comprises basically a supporting substrate 200 of a suitable non-magnetic material such as glass, with an overlying coating 202 of a suitable and conventional magnetic layer.

FIG. 2B shows the operative relationship between a conventional recording/playback head 204, which may preferably be a thin film head, and a conventional recording medium, such as that of FIG. 2A.

FIG. 2C illustrates, schematically, the orientation of magnetic impulses substantially perpendicular to the surface of a recording medium as used with magnetic disc recording systems, such as that shown in FIG. 1. For such perpendicular recording the medium typically includes an under layer 212 of a material having a high magnetic permeability. This under layer 212 is then provided with an overlying coating 214 of magnetic material preferably having a high coercivity relative to the under layer 212.

FIG. 2D illustrates the operative relationship between a perpendicular head 218 and a recording medium. The recording medium illustrated in FIG. 2D includes both the high permeability under layer 212 and the overlying coating 214 of magnetic material described with respect to FIG. 2C above. However, both of these layers 212 and 214 are shown applied to a suitable substrate 216. Typically there is also an additional layer (not shown) called an “exchange-break” layer or “interlayer” between layers 212 and 214.

In this structure, the magnetic lines of flux extending between the poles of the perpendicular head 218 loop into and out of the overlying coating 214 of the recording medium with the high permeability under layer 212 of the recording medium causing the lines of flux to pass through the overlying coating 214 in a direction generally perpendicular to the surface of the medium to record information in the overlying coating 214 of magnetic material preferably having a high coercivity relative to the under layer 212 in the form of magnetic impulses having their axes of magnetization substantially perpendicular to the surface of the medium. The flux is channeled by the soft underlying 212 back to the return layer (P1) of the head 218.

FIG. 2E illustrates a similar structure in which the substrate 216 carries the layers 212 and 214 on each of its two opposed sides, with suitable recording heads 218 positioned adjacent the outer surface of the magnetic coating 214 on each side of the medium, allowing for recording on each side of the medium.

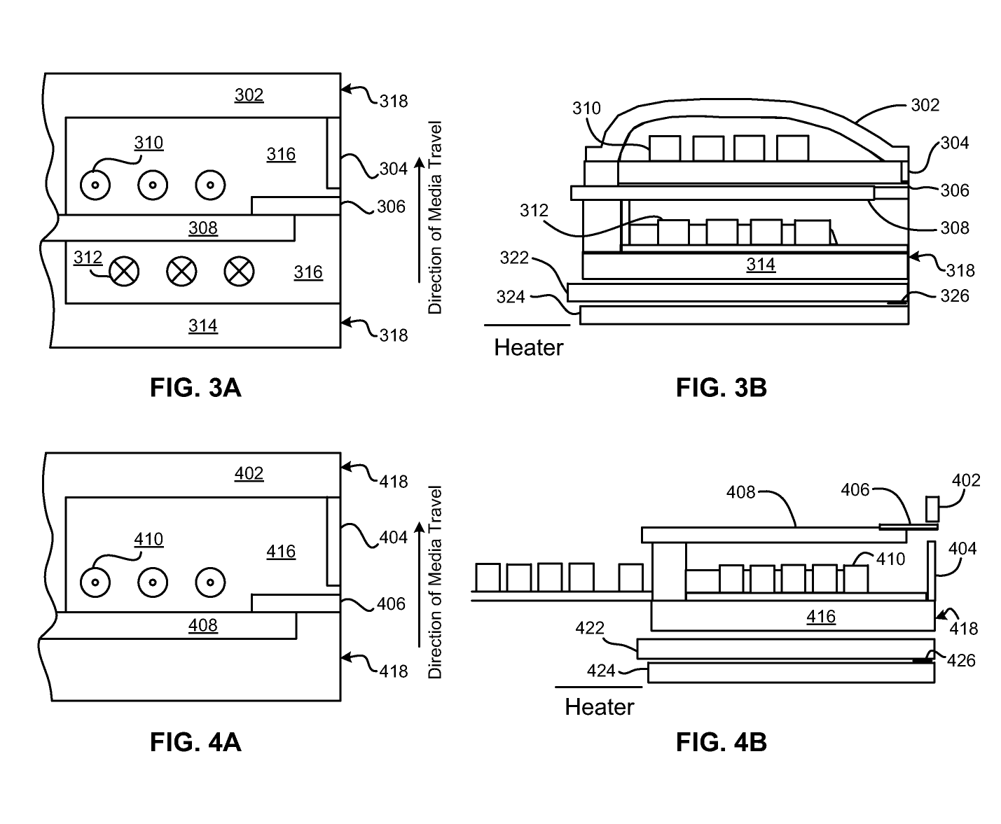

FIG. 3A is a cross-sectional view of a perpendicular magnetic head. In FIG. 3A, helical coils 310 and 312 are used to create magnetic flux in the stitch pole 308, which then delivers that flux to the main pole 306. Coils 310 indicate coils extending out from the page, while coils 312 indicate coils extending into the page. Stitch pole 308 may be recessed from the ABS 318. Insulation 316 surrounds the coils and may provide support for some of the elements. The direction of the media travel, as indicated by the arrow to the right of the structure, moves the media past the lower return pole 314 first, then past the stitch pole 308, main pole 306, trailing shield 304 which may be connected to the wrap around shield (not shown), and finally past the upper return pole 302. Each of these components may have a portion in contact with the ABS 318. The ABS 318 is indicated across the right side of the structure.

Perpendicular writing is achieved by forcing flux through the stitch pole 308 into the main pole 306 and then to the surface of the disk positioned towards the ABS 318.

FIG. 3B illustrates a piggyback magnetic head having similar features to the head of FIG. 3A. Two shields 304, 314 flank the stitch pole 308 and main pole 306. Also sensor shields 322, 324 are shown. The sensor 326 is typically positioned between the sensor shields 322, 324.

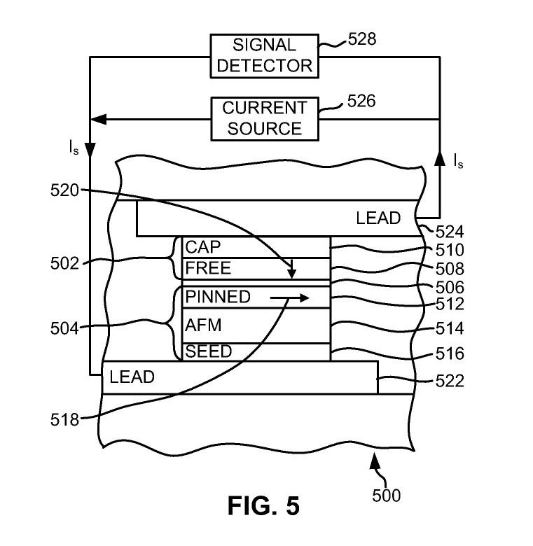

FIG. 4A is a schematic diagram of one embodiment which uses looped coils 410, sometimes referred to as a pancake configuration, to provide flux to the stitch pole 408. The stitch pole then provides this flux to the main pole 406. In this orientation, the lower return pole is optional. Insulation 416 surrounds the coils 410, and may provide support for the stitch pole 408 and main pole 406. The stitch pole may be recessed from the ABS 418. The direction of the media travel, as indicated by the arrow to the right of the structure, moves the media past the stitch pole 408, main pole 406, trailing shield 404 which may be connected to the wrap around shield (not shown), and finally past the upper return pole 402 (all of which may or may not have a portion in contact with the ABS 418). The ABS 418 is indicated across the right side of the structure. The trailing shield 404 may be in contact with the main pole 406 in some embodiments.

FIG. 4B illustrates another type of piggyback magnetic head having similar features to the head of FIG. 4A including a looped coil 410, which wraps around to form a pancake coil. Also, sensor shields 422, 424 are shown. The sensor 426 is typically positioned between the sensor shields 422, 424.

In FIGS. 3B and 4B, an optional heater is shown near the non-ABS side of the magnetic head. A heater (Heater) may also be included in the magnetic heads shown in FIGS. 3A and 4A. The position of this heater may vary based on design parameters such as where the protrusion is desired, coefficients of thermal expansion of the surrounding layers, etc.

Except as otherwise described herein, the various components of the structures of FIGS. 3A-4B may be of conventional materials and design, as would be understood by one skilled in the art.

As described above, the free layer of a magnetic recording head may be a composite free layer, e.g., including at least two free layers separated by a thin non-magnetic spacer. The portions of the free layer on each side of spacer may each, independently of the other, have a single ferromagnetic layer or multiple ferromagnetic layers. Moreover, various embodiments described and/or suggested herein may exhibit ferromagnetic coupling between such free layers through the spacer layer, thereby preferably influencing a magnetic orientation, e.g., out of a plane of deposition thereof. As a result, the hard magnetic biasing layer can be eliminated, and a high TMR ratio can be obtained. Moreover, potential free layer noise reduction can be expected through damping reduction due to the inserting layer provides magnetic damping reduction of both the first and second free layer.

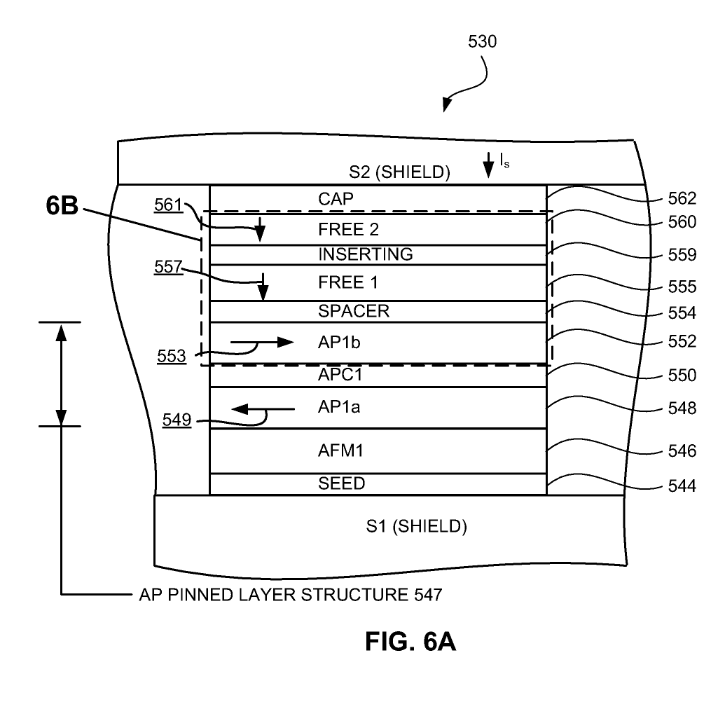

According to an exemplary embodiment, which is in no way intended to limit the invention, “a” layer in the following paragraph is intended to include a structural block that can have a single layer or multiple layers. FIG. 5 shows a MTJ sensor 500 comprising a first electrode 504, a second electrode 502, and a tunnel barrier layer 506. The first electrode 504 comprises a ferromagnetic pinned layer 512, an antiferromagnetic (AFM) layer 514, and a seed layer 516 that can be magnetic and/or non-magnetic layers. The magnetization of the pinned layer 512 is fixed through exchange coupling with the AFM layer 514. The second electrode 502 comprises a ferromagnetic free layer 508 and a cap layer 510. The free layer 508 is separated from the pinned layer 512 by a nonmagnetic spacer layer, where the spacer layer can be an electrically insulating tunnel barrier layer 506 in the MTJ sensor configuration, or a conductive metal spacer layer in other embodiments such as MR, GMR and AMR sensors. In the absence of an external magnetic field, the free layer 508 has its magnetization oriented in the direction shown by arrow 520, that is, generally perpendicular to the X-Y deposition plane 512 shown by arrow 518. A first lead 522 and a second lead 524 formed in contact with first electrode 504 and second electrode 502, respectively, provide electrical connections for the flow of sensing current Iₛ from a current source 526 to the MTJ sensor 500. Because the sensing current is perpendicular to the plane of the sensor layers, the MTJ sensor 500 is known as a current-perpendicular-to-plane (CPP) sensor. A signal detector 528, typically including a recording channel such as a partial-response maximum-likelihood (PRML) channel, connected to the first and second leads 522 and 524 senses the change in resistance due to changes induced in the free layer 508 by the external magnetic field.

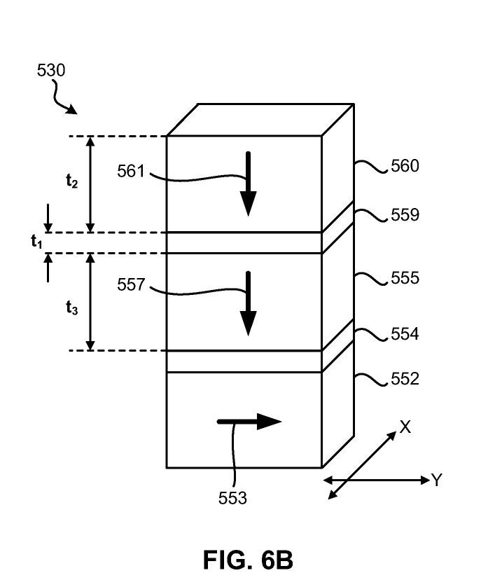

FIG. 6A shows an air bearing surface (ABS) view, not to scale, of a magnetic sensor 530 according to another embodiment. As an option, the present sensor 530 may be implemented in conjunction with features from any other embodiment listed herein, such as those described with reference to the other FIGS. Of course, however, such sensor 530 and others presented herein may be used in various applications and/or in permutations which may or may not be specifically described in the illustrative embodiments listed herein. Further, the sensor 530 presented herein may be used in any desired environment. Thus FIG. 6A (and the other FIGS.) should be deemed to include any and all possible permutations.

The seed layer 544 is a layer deposited to modify the crystallographic texture or grain size of the subsequent layers, and may not be needed depending on the subsequent layer. A first MTJ stack deposited over the seed layer 544 comprises a first antiferromagnetic (AFM1) layer 546, a first AP-pinned layer 547, a spacer layer 554 which may be an electrically insulating tunnel barrier layer or a metal spacer layer, and a first free layer 555. The AP-pinned layer structure 547 is formed of two ferromagnetic layers 548 and 552 separated by an antiparallel coupling (APC) layer 550. The APC layer is formed of a nonmagnetic material, preferably ruthenium (Ru) that allows the two ferromagnetic layers 548 and 552 to be strongly antiparallel-coupled together. The AFM1 layer 546 has a thickness at which the desired exchange properties are achieved, typically 30-300 Å.

The AFM1 layer 546 is exchange-coupled to the first AP-pinned layer 547 to provide a pinning magnetic field to pin the magnetizations of the two ferromagnetic layers of the AP-pinned layer structure 547 in the planes of deposition thereof, as indicated by arrow 549 and arrow 553, respectively. The AP-pinned layer 552 closest to the first free layer 555 is the reference layer of the sensor 530.

Illustrative materials for the AP pinned layers 548, 552 are CoFeₓ and/or NiFeₓ alloys where x is 0 at % to 100 at %. Moreover, the AP pinned layers may each be a single layer or laminated layers. Illustrative thicknesses of the AP pinned layers 548, 552 are between about 10 Å and 50 Å. The antiparallel coupling layer 550 can be formed of Ru at a thickness about 3-12 Å. Referring to FIGS. 6A and 6B, the reference layer 552, also often referred to as a pinned layer (e.g., see also pinned layer 512) may have a magnetic orientation (signified by the arrow 553) about aligned with a plane of deposition (X-Y plane) thereof. In different approaches, this pinned magnetic orientation of the reference layer 552 may be used when reading data from a magnetic medium (not shown), e.g., by acting as a reference orientation when analyzing the changing magnetic orientation of a given free layer, as would be appreciated by one skilled in the art upon reading the present description. According to one approach, the magnetization of the reference layer 552 may be fixed through exchange coupling with an AFM layer (e.g., see 514).

The magnetic head also includes a spacer layer 554 positioned between the reference layer 552 and the first free layer 555. The spacer layer 554 may be a tunnel barrier layer 554 formed of a dielectric barrier material, such as Al₂O₃, MgOₓ etc. The tunnel barrier layer 554 is very thin such that the electric current passing through the sensor 530 “tunnels” through the tunnel barrier layer. An illustrative thickness of the tunnel barrier layer is 3-10 Å. The spacer layer may alternatively be a metal layer, such as Cu, Ag, AgSn etc., with a thickness typically in the range of 20-100 Å.

With continued reference to FIGS. 6A-6B, the sensor 530 includes a first free layer 555 above the spacer layer. As described above, the magnetic orientation of the first free layer is free to rotate in the presence of an external magnetic field, e.g., originating from a magnetic medium from which data is being read. According to various approaches, the first free layer 555 may include NiFe, CoFe, CoFeB, Fe, diluted magnetic materials, etc., or any other suitable material.

The first free layer 555 may have a magnetic orientation (signified by the arrow 557) out of a plane of deposition (X-Y plane) when there is no applied field, for example, a field from media. In one preferred approach, the magnetic orientation of the first free layer 555 may be about perpendicular to the plane of deposition thereof (X-Y plane) and about perpendicular to the magnetic orientation of the reference layer 552. In other approaches, the magnetic orientation of the first free layer 555 may be perpendicular to the plane of deposition or have a magnetic orientation in between in-plane and perpendicular to the plane. Moreover, according to a preferred approach, the magnetic orientation of the first free layer 555 when at rest in the head can also be induced by the magnetic orientation of the second free layer 560, as will soon become apparent.

With continued reference to FIGS. 6A-6B, the sensor 530 includes a second free layer 560 which has a magnetic orientation (signified by the arrow 561) out of a plane of deposition thereof as illustrated. In a preferred approach, the magnetic orientation of the second free layer 560 may be about perpendicular to the plane of deposition thereof (X-Y plane) and perpendicular to the magnetic orientation of the reference layer 552. In various approaches, the second free layer 560 is a magnetic layer, which may include, but is not limited to, Co—Ni multilayer, TbCoFe, FePt, MnGa, CoFeB, Co₂FeAl, Co—Pd multilayer, and Co—Pt multilayered structure, etc. According to some approaches, the second free layer 560 may have the same or similar composition as the first free layer 555. However, in various approaches, the first and second free layers 555, 560 may have different compositions as will soon become apparent.

Additionally, an inserting layer 559 is positioned between the first and second free layers 555, 560. The inserting layer 559 is characterized as tuning (inducing) ferromagnetic coupling between the first and second free layers 555, 560, and also acting as a growth template for the second free layer, thereby promoting growth of the second free layer. The second free layer 560 has a higher anisotropy than the first free layer 555. The ferromagnetic coupling induced by the inserting layer 559 causes the first free layer 555 to have an out of plane magnetization induced by the interlayer ferromagnetic coupling and stronger out of plane (e.g., perpendicular) anisotropy of the second free layer 560.

In some embodiments, the first and second free layers 555, 560 may have different compositions. In a preferred approach, the first free layer 555 may have a higher spin polarization and a lower perpendicular anisotropy than the second free layer 560. As a result, the magnetic orientation of the second free layer 560 may induce the magnetic orientation of the first free layer 555 through the interlayer coupling formed by the inserting layer 559. However, in various approaches, the ferromagnetic coupling between the first and second free layers 555, 560 may depend on the thickness, material, growth, etc. of the inserting layer 559 relative to both the first and second free layers 555, 560. Moreover, in another approach, the overall perpendicular anisotropy of the combined free layers 555, 560 may be adjusted by the selected of a low perpendicular anisotropy of the first free layer 555 and a high perpendicular anisotropy of the second free layer 560.

According to an exemplary embodiment, which is in no way intended to limit the invention, the smaller the thickness t₁ of the inserting layer 559 the stronger the interlayer ferromagnetic coupling between the first and second free layers 555, 560. Moreover, the smaller the thickness t₃ of the first free layer 555, the greater effect the second free layer has on the first free layer 555. Thus, different relationships between the characteristics thereof may result in a stronger or weaker ferromagnetic coupling between the first and second free layers 555, 560. In some approaches, the first free layer 555 may be formed with a magnetic orientation about aligned with a plane of deposition thereof, and the ferromagnetic coupling with the second free layer 560 is sufficient to reorient the magnetization direction of the first free layer 555 to the desired orientation.

According to various approaches, the inserting layer 559 is nonmagnetic, and may be electrically conductive or nonconductive. Illustrative materials for the inserting layer 559 include metal oxides such as MgO, Ta, Ti, heavy metals or light metals, etc. or any other suitable spacer material which would be apparent to one skilled in the art upon reading the present description. The insertion material is not only used to tune the coupling field between the first and second free layer, it also can be engineered to reduce magnetic damping constants of both the first and second free layers, potentially leading to noise reduction and head signal to noise gain.

It follows that the thickness, materials, growth, etc. of the inserting layer 559, and/or of the first and second free layers 555, 560 may be tuned to achieve the desired ferromagnetic coupling between the first and second free layers 555, 560, thereby causing the magnetic orientation of the first free layer 555 to be out of a plane of deposition (X-Y plane) when at rest in the sensor 530. As a result, a sensor, e.g., such as that illustrated in FIGS. 5-6B, may be optimized for different sensing environments, platforms, conditions, etc.

As described above, the first free layer 555 has a magnetic orientation out of a plane of deposition thereof, and in some approaches, about perpendicular to the plane of deposition thereof, when at rest in the head in the absence of external magnetic forces. The magnetic orientation of the first free layer 555 is biased in right configuration with respect to the ABS without the use of one or more hard bias material layers. Thus, as illustrated in FIGS. 6A-6B, the sensor 530 may not include hard bias layers to impose a bias on the magnetic orientation of the first free layer 555. As a result, hard bias induced magnetic instability can be reduced and reader process content/alignment challenge can be greatly reduced.

Moreover, by removing the one or more biasing layers seen in conventional products, the complexity of magnetic read head fabrication processes is desirably reduced, while maintaining efficient performance thereof.

Referring again to FIGS. 6A-6B, a cap 562 may be formed above the second free layer 560.

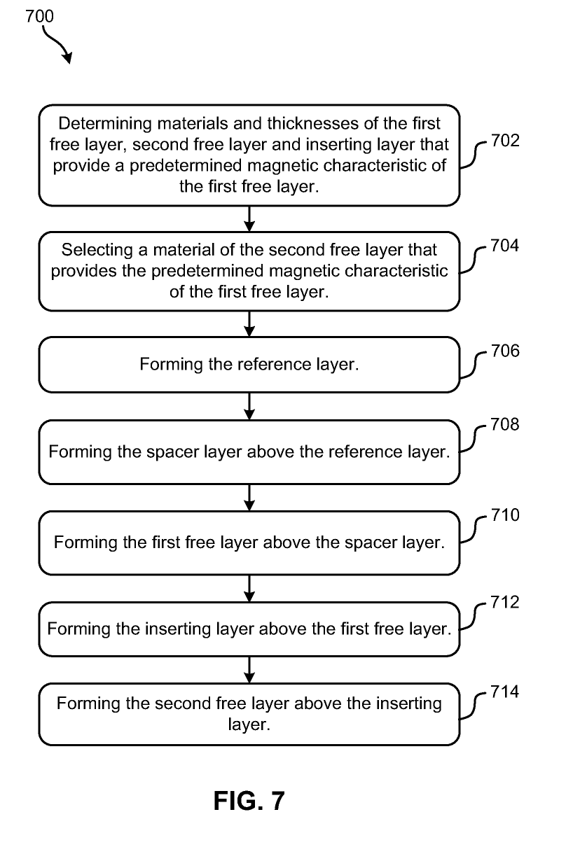

Any of the approaches described and/or suggested herein may be formed using various methods. However, FIG. 7 illustrates preferred process steps of a method for forming a magnetic head, e.g., such as that shown in FIG. 5 or 6A, according to an exemplary embodiment.

FIG. 7 depicts a method 700 for forming a magnetic head, in accordance with one embodiment. As an option, the present method 700 may be implemented in conjunction with features from any other embodiment listed herein, such as those described with reference to the other FIGS. Of course, however, such method 700 and others presented herein may be used in various applications and/or in permutations which may or may not be specifically described in the illustrative embodiments listed herein. Further, the method 700 presented herein may be used in any desired environment. Thus FIG. 7 (and the other FIGS.) should be deemed to include any and all possible permutations.

Referring now to FIG. 7, the method 700 includes determining materials and thicknesses of the first free layer, second free layer and inserting layer that provide a predetermined magnetic characteristic of the first free layer as well as have a high MR ratio. See operation 702. As described above, in a preferred approach the physical characteristics (e.g., including the thicknesses, compositions, etc.) of the first free layer, second free layer and inserting layer may determine the ferromagnetic coupling between the first and second free layers. The magnetic characteristic may include one or more of the damping factor, the stiffness of the magnetic orientation of the first free layer, an extent of interlayer coupling between the free layers, etc.

According to various approaches, the thickness or any other characteristic of the first free layer, second free layer and/or inserting layer may be determined using and/or in light of program code; modeling; user input; predetermined values, e.g., from a user, stored in memory (e.g., a lookup table), etc.; based on the operating conditions; etc.

With continued reference to FIG. 7, the method 700 includes selecting a material of the second free layer that provides the predetermined magnetic characteristic of the first free layer. See operation 704. According to different approaches, the material of the second free layer may include any of the materials described and/or suggested herein, depending on the desired embodiment. Moreover, in one approach, the material selected may be determined, at least in part, by the thickness determined in operation 702 of the method 700. According to different approaches, the material may be selected by using computer code, a controller, user input, operating conditions, predetermined characteristics of a magnetic head, etc.

Note that operations 702 and 704 may be performed concurrently, in dependence upon one another to select the appropriate combination of physical characteristics.

The method 700 further includes forming the reference layer in operation 706, forming the spacer layer above the reference layer in operation 708, forming the first free layer above the spacer layer in operation 710, forming the inserting layer above the first free layer in operation 712 and forming the second free layer above the inserting layer in operation 714. Conventional fabrication techniques may be used in operations 706-714.

Moreover, according to various other approaches, the layers formed in operations 706-714 may include any of the illustrative materials, dimensions, thickness characteristics, etc. described above, depending on the desired embodiment. However, in a preferred approach, the thickness of the first free layer and the material of the second free layer as determined in operations 702 and 704, are implemented in their corresponding formation operations 710, 714 of method 700, respectively.

It should be noted that methodology presented herein for at least some of the various embodiments may be implemented, in whole or in part, in computer hardware, software, by hand, using specialty equipment, etc. and combinations thereof.

Moreover, any of the structures and/or steps may be implemented using known materials and/or techniques, as would become apparent to one skilled in the art upon reading the present specification.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

1. A magnetic head, comprising:
a reference layer having magnetic orientation about aligned with a plane of deposition thereof;
a first free layer having a magnetic orientation out of a plane of deposition thereof;
a spacer layer between the reference layer and the first free layer;
a second free layer having a magnetic orientation out of a plane of deposition thereof; and
an inserting layer between the first and second free layers,
wherein the magnetic orientation of the first free layer is oriented in about a same direction as the magnetic orientation of the second free layer.

2. The magnetic head as recited in claim 1, wherein the magnetic orientation of the first free layer is about perpendicular to the plane of deposition thereof.

3. The magnetic head as recited in claim 7, wherein the first free layer has a higher spin polarization and a perpendicular anisotropy than the second free layer.

4. The magnetic head as recited in claim 1, wherein the inserting layer is nonmagnetic, wherein the inserting layer is characterized as tuning ferromagnetic coupling between the first and second free layers, and promoting growth of the second free layer.

5. The magnetic head as recited in claim 1, wherein the inserting layer is a metal oxide or metal.

6. The magnetic head as recited in claim 1, wherein the inserting layer provides magnetic damping reduction of both the first and second free layers.

7. The magnetic head as recited in claim 1, wherein the first and second free layers have a same composition.

8. The magnetic head as recited in claim 1, with a proviso that the magnetic head does not have hard bias layers.

9. The magnetic head as recited in claim 1, wherein the first free layer has a higher spin polarization and a lower perpendicular anisotropy than the second free layer.

10. A magnetic data storage system, comprising:
at least one magnetic head as recited in claim 1;
a magnetic medium;
a drive mechanism for passing the magnetic medium over the at least one magnetic head; and
a controller electrically coupled to the at least one magnetic head for controlling operation of the at least one magnetic head.

11. A method for forming the magnetic head of claim 1, the method comprising:
forming the reference layer;
forming the spacer layer above the reference layer;
forming the first free layer above the spacer layer;
forming the inserting layer above the first free layer; and
forming the second free layer above the inserting layer.

12. The method as recited in claim 11, further comprising determining thicknesses of the first free layer, second free layer and inserting layer that provide a predetermined magnetic characteristic of the first free layer.

13. The method as recited in claim 11, further comprising selecting a material and thickness of the second free layer and the inserting layer that provide a predetermined magnetic characteristic of the first free layer.

14. A magnetic head, comprising:
a reference layer having magnetic orientation about aligned with a plane of deposition thereof;
a first free layer having a magnetic orientation about perpendicular to a plane of deposition thereof;
a spacer layer between the reference layer and the first free layer;
a second free layer having a magnetic orientation about perpendicular to a plane of deposition thereof; and
a nonmagnetic inserting layer between the first and second free layers,
wherein the magnetic orientation of the first free layer is oriented in about a same direction as the magnetic orientation of the second free layer.

15. The magnetic head as recited in claim 18, wherein the first free layer has a higher spin polarization and a lower perpendicular anisotropy than the second free layer.

16. The magnetic head as recited in claim 14, wherein the inserting layer is a metal oxide or metal.

17. The magnetic head as recited in claim 14, wherein the inserting layer provides magnetic damping reduction of both the first and second free layers.

18. The magnetic head as recited in claim 14, wherein the first and second free layers have a same composition.

19. The magnetic head as recited in claim 14, with a proviso that the magnetic head does not have hard bias layers.

20. The magnetic head as recited in claim 14, wherein the first free layer has a higher spin polarization and a lower perpendicular anisotropy than the second free layer.

21. A magnetic data storage system, comprising:
at least one magnetic head as recited in claim 14;
a magnetic medium;
a drive mechanism for passing the magnetic medium over the at least one magnetic head; and
a controller electrically coupled to the at least one magnetic head for controlling operation of the at least one magnetic head.

22. A method for forming the magnetic head of claim 14, the method comprising:
determining a material and thicknesses of the first free layer, second free layer and inserting layer that provide a predetermined magnetic characteristic of the first free layer;
selecting a material of the second free layer that provides the predetermined magnetic characteristic of the first free layer;
forming the reference layer;
forming the spacer layer above the reference layer;
forming the first free layer above the spacer layer;
forming the inserting layer above the first free layer; and
forming the second free layer above the inserting layer.
